(19) United States
(12) Patent Application Publication
(10) Pub. No.: US 2022/0245470 A1
(43) Pub. Date: Aug. 4, 2022

(54) AUTOMATICALLY GENERATING AN APPLICATION KNOWLEDGE GRAPH

(71) Applicant: Asserts Inc., San Ramon, CA (US)

(72) Inventors: Manoj Acharya, Pleasanton, CA (US); Jia Xu, Tiburon, CA (US); Jim Gehrett, Larkspur, CA (US)

(73) Assignee: Asserts Inc., San Ramon, CA (US)

(21) Appl. No.: 17/339,985

(22) Filed: Jun. 5, 2021

Related U.S. Application Data
(60) Provisional application No. 63/144,982, filed on Feb. 3, 2021.

(51) Int. Cl. G06N 5/02; H04L 29/08

(52) U.S. Cl. CPC G06N 5/022; H04L 67/34

(57) ABSTRACT

A system that automatically monitors an application without requiring administrators to manually identify what portions of the application should be monitored. The present system is flexible in that it can be deployed in several different environments having different operating parameters and nomenclature. The present application is able to automatically monitor applications in the different environments, and convert data, metric, and event nomenclature of the different environments to a universal nomenclature. A system graph is then created from the nodes and metrics of each environment application that make up a client system. The system graph, and the properties of entities within the graph, can be displayed through an interface to a user.

### CROSS REFERENCE TO RELATED APPLICATIONS

The present application claims the priority benefit of U.S. provisional patent application 63/144,982, filed on Feb. 3, 2021, titled “AUTOMATICALLY GENERATING AN APPLICATION KNOWLEDGE GRAPH,” the disclosures of which are incorporated herein by reference.

### BACKGROUND

Application monitoring systems can operate to monitor applications that provide a service over the Internet. Typically, the administrator of the operating application provides specific information about the application to administrators of the monitoring system. The specific information indicates exactly what portions of the application to monitor. The specific information is static, in that it cannot be changed, and the monitoring system has no intelligence as to why it is monitoring a specific portion of a service. What is needed is an improved system for monitoring applications.

### SUMMARY

The present technology, roughly described, automatically monitors an application without requiring administrators to manually identify what portions of the application should be monitored. The present system is flexible in that it can be deployed in several different environments having different operating parameters and nomenclature. The present application is able to automatically monitor applications in the different environments, and convert data, metric, and event nomenclature of the different environments to a universal nomenclature. A system graph is then created from the nodes and metrics of each environment application that make up a client system. The system graph, and the properties of entities within the graph, can be displayed through an interface to a user.

In some instances, a method automatically generates an application knowledge graph. The method begins with receiving a first set of metrics with labels from one or more agents monitoring a client system in one or more computing environments. The first set of received metrics and labels can have a universal nomenclature that is different than a native computing environment nomenclature for the metrics and labels. The method continues with analyzing the first set of received metrics and labels to identify the metrics and labels, and then automatically generating a knowledge graph based on the set of metrics and labels. A new set of metrics and labels can be retrieved from the one or more agents, and the knowledge graph is automatically updated based on the new set of metrics and labels. The updated knowledge graph data is then reported to a user.

In embodiments, a system can include a server, memory and one or more processors. One or more modules may be stored in memory and executed by the processors to receive a first set of metrics with labels from one or more agents monitoring a client system in one or more computing environments, the first set of received metrics and labels having a universal nomenclature that is different than a native computing environment nomenclature for the metrics and labels, analyze the first set of received metrics and labels to identify the metrics and labels, automatically generate a knowledge graph based on the set of metrics and labels, receive a new set of metrics and labels from the one or more agents, automatically update the knowledge graph based on the new set of metrics and labels, and report the updated knowledge graph data to a user.

### BRIEF DESCRIPTION OF FIGURES

FIG. 1 is a block diagram of a system for monitoring a cloud service.

FIG. 2 is a block diagram of an agent.

FIG. 3 is a block diagram of an application.

FIG. 4 is a method for monitoring a cloud service.

FIG. 5 is a method for retrieving metric, label, and event data at a client machine based on a rule configuration file.

FIG. 6 is a method for transforming label data into a specified nomenclature.

FIG. 7 is a method for processing data by an application.

FIG. 8 is a method for reporting process data through an interface.

FIG. 9 illustrates a node graph for a monitored system.

FIG. 10 illustrates properties provided for a selected node in a node graph for a monitored system.

FIG. 11 illustrates a user interface for reporting a cloud service data.

FIGS. 12 A-B illustrates properties reported for cloud service entity.

FIG. 13 illustrates a dashboard for reporting cloud service data.

FIG. 14 illustrates a computing environment for implementing the present technology.

### DETAILED DESCRIPTION

The present technology, roughly described, automatically monitors an application without requiring administrators to manually identify what portions of the application should be monitored. The present system is flexible in that it can be deployed in several different environments having different operating parameters and nomenclature. The present application is able to automatically monitor applications in the different environments, and convert data, metric, and event nomenclature of the different environments to a universal nomenclature. A system graph is then created from the nodes and metrics of each environment application that make up a client system. The system graph, and the properties of entities within the graph, can be displayed through an interface to a user.

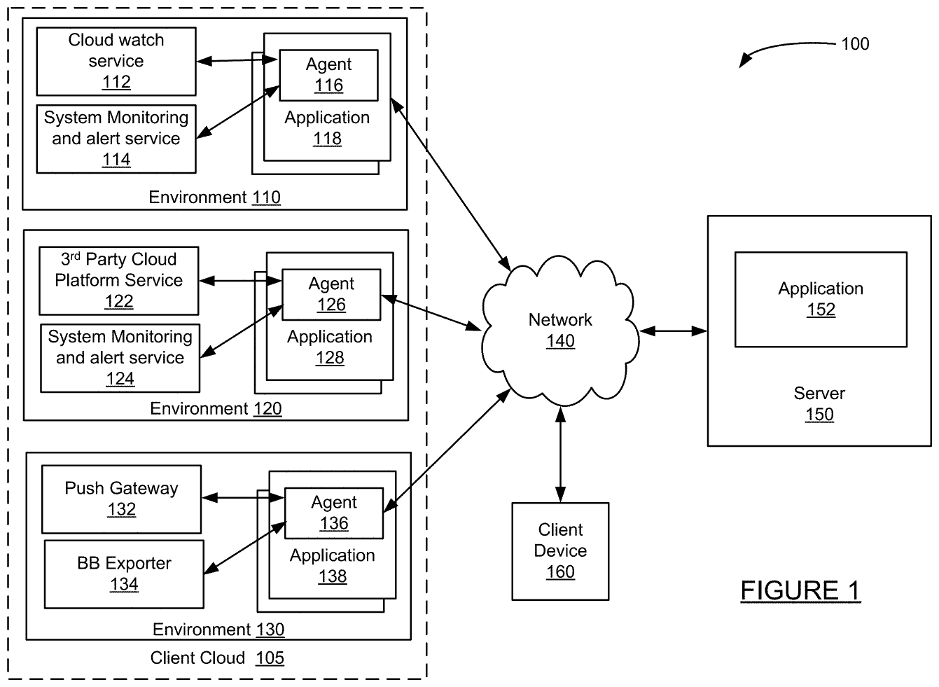

FIG. 1 is a block diagram of a system for monitoring a cloud service. The system of FIG. 1 includes client cloud 105, network 140, and server 150. Client cloud 105 includes environment 110, environment 120, and environment 130. Each of environments 110-130 may be provided one or more cloud computing providers, such as a company that provides computing resources over network. Examples of a cloud computing service include “Amazon Web Service” and “Google Cloud Platform,” and “Microsoft Azure.” Environment 110, for example, includes cloud watch service 112, system monitoring and alert service 114, and client application 118. Cloud watch service 112 may be a service provided by the cloud computing provider of environment 110 that provides data and metrics regarding events associated with an application executing in environment 110 as well as the status of resources in environment 110. System monitoring and alert service 114 may include a third-party service that provides monitoring and alerts for an environment. An example of a system monitoring and alert service 114 includes “Prometheus,” an application used for event monitoring and alerting.

Client application 118 may be implemented as one or more applications on one or more machines that implement a system to be monitored. The system may exist in one or more environments, for example environments 110, 120, and/or 130.

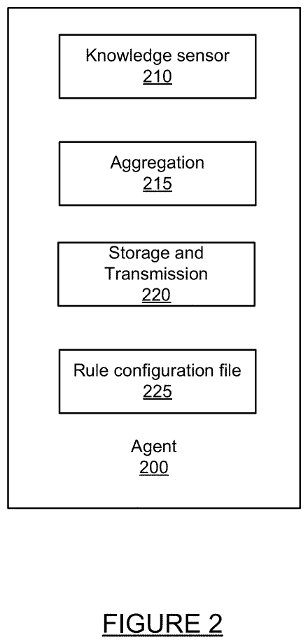

Agent 116 may be installed in one or more client applications within environment 110 to automatically monitor the client application, detect metrics and events associated with client application 118, and communicate with the system application 152 executing remotely on server 150. Agent 116 may detect new knowledge about client application 118, aggregate data, and store and transmit the knowledge and aggregated data to server 150. Client application 118 may automatically perform the detection, aggregation, storage, and transmission based on one or more files, such as a rule configuration file. Agent 116 may be installed with an initial rule configuration file and may subsequently receive updated rule configuration files as the system automatically learns about the application being monitored. More detail for agent 116 is discussed with respect to agent 200 of FIG. 2.

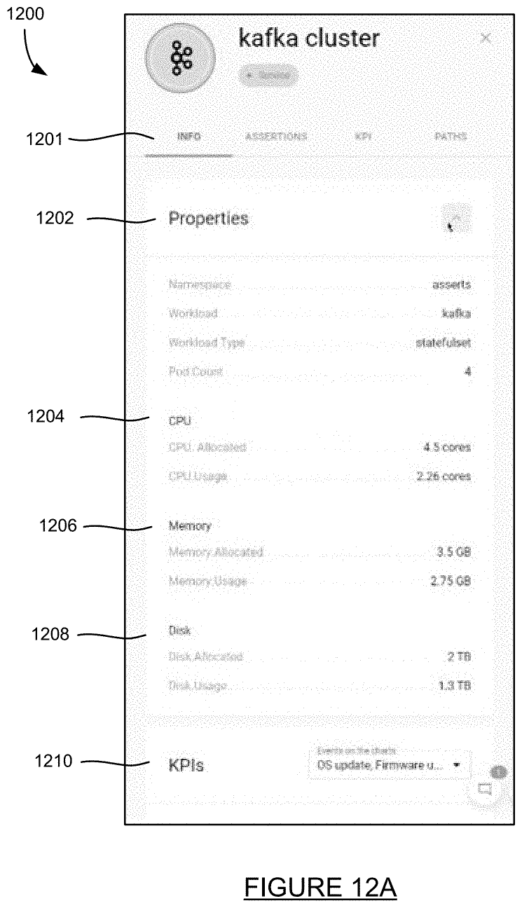

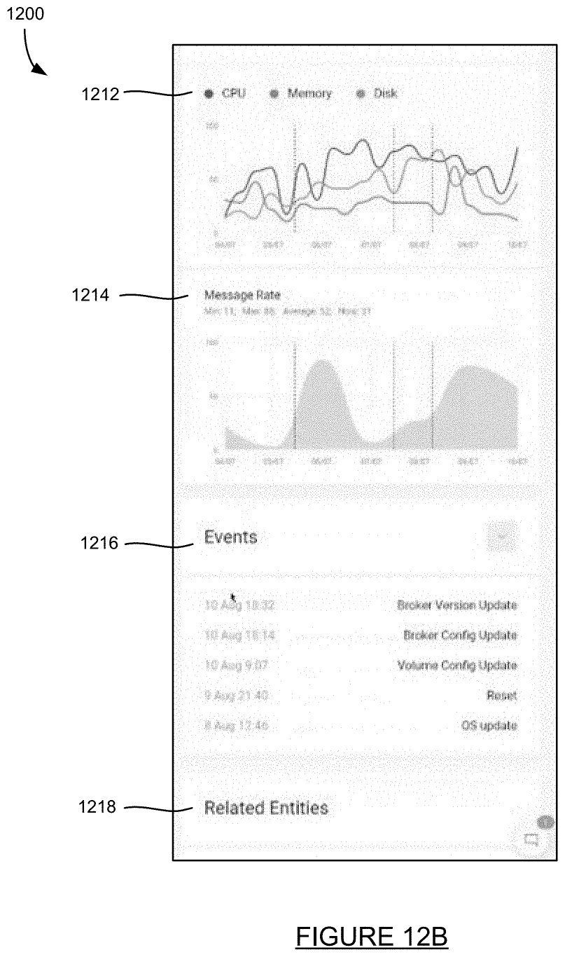

Environment 120 may include a third-party cloud platform service 122 and a system monitoring and alert service 124, as well as client application 128. Agent 126 may execute on client application 128. The system monitoring alert service 124, client application 128, and agent 126 may be similar to those of environment 110. In particular, agent 126 may monitor the third-party cloud platform service, application 128, and system monitoring and alert service, and report to application 152 on system server 150. The third-party cloud platform service may provide environment 120, including one or more servers, memory, nodes, and other aspects of a “cloud” FIG. 12 illustrates a computing environment for implementing the present technology.

Environment 130 may include client application 138 and agent 136, similar to environments 110 and 120. In particular, agent 136 may monitor the cloud components and client application 138, and report to application 152 on server 150. Environment 130 may also include a push gateway 132 and BB exporter 134 that communicate with agent 136. The push gateway and BB exporter may be used to process batch jobs or other specified functionality.

Network 140 may include one or more private networks, public networks, local area networks, wide-area networks, an intranet, the Internet, wireless networks, wired networks, cellular networks, plain old telephone service networks, and other network suitable for communicating data. Network 140 may provide an infrastructure that allows agents 116, 126, and 136 to communicate with application 152.

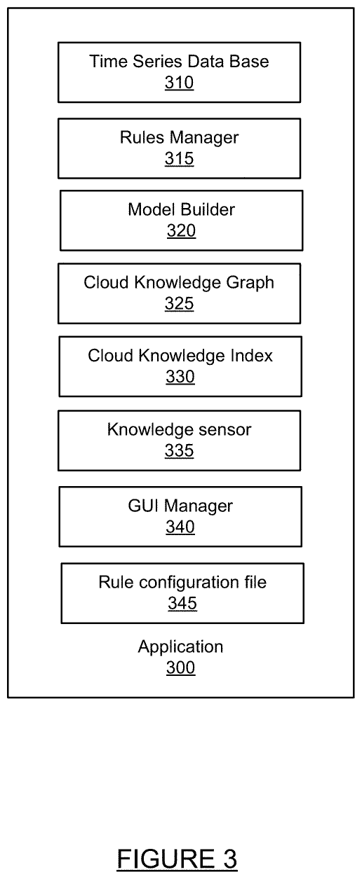

Server 150 may include one or more servers that communicate with agents 116, 126 and 136 over network 140. Application 150 executes on server 150. Application 152 may be implemented on one or more servers. In some instances, application 152 may execute on one or more servers 150 in an environment provided by a cloud computing provider. Application 152 may include a timeseries database, rules manager, model builder, cloud knowledge graph, cloud knowledge index, one or more rule configuration files, and other modules and data. Application 152 is described in more detail with respect to FIG. 3.

FIG. 2 is a block diagram of an agent. Agent 200 of FIG. 2 provides more detail for each of agents 116, 126, and 136 of FIG. 1. Agent 200 includes knowledge sensor 210, aggregation 215, storage and transmission 220, and rule configuration file 225. Knowledge sensor 210 may execute one or more rule configuration files 225 to identify new knowledge data for an application on which the agent is executing, the environment in which it executes in, resources used by the application, and other metrics or events.

Rule configuration file 225 may specify what metrics and events are to be captured, how the data is to be aggregated, how long data is to be stored or cached before transmission, and the transmission details for the data. Agent 200 can be loaded with an initial rule configuration file 225, and receive updated rule configuration files as the agent monitors an application and reports data to a remote application. Periodically, agent 200 will receive updates to rule configuration file 225. In some instances, the rule configuration file is updated when new knowledge is detected and provided to application 152. The updates may be sent periodically, in response to an event at application 152 on server 150, or in response to a rule configuration file request from agent 200. The rule configuration file 225 includes data indicating which endpoints to monitor in the client application, cloud watch service, and the third-party system monitoring alert service.

Aggregation 215 may aggregate data collected by knowledge sensor 210. The data may be aggregated in one or more ways, including data for a particular node, metric, pod, and/or in some other way. The aggregation may occur as outlined in a rule configuration file 225 received by the agent 200 from application 152.

Aggregated data may be stored and then transmitted by storage and transmission component 220. The aggregated data may be stored until it is periodically sent to application 152. In some instances, the data is stored for a period of time, such as 10 seconds, 20 seconds, 30 seconds, one minute, five minutes, or some other period of time. In some instances, aggregated data may be transmitted to application 152 in response to a request from application 152 or based on an event detected at agent 200.

FIG. 3 is a block diagram of an application. The application 300 of FIG. 3 provides more detail for application 152 on server 150 of FIG. 1. Application 300 includes timeseries database 310, rules manager 315, model builder 320, cloud knowledge graph 325, cloud knowledge index 330, knowledge sensor 335, GUI manager 340, and rule configuration file 345. Each of the modules 310-345 may perform functionality as described herein. Application 300 may include additional or fewer modules, and each module may be implemented with one or more actual modules, located on a single application, or distributed over several applications or servers.

Timeseries database 310 may be included within application 300 or may be implemented as a separate application. In some instances, timeseries database 310 may be implemented on a machine other than server 150. Timeseries database may receive timeseries data from agents 116-136 and store the time series data. Timeseries database 310 may also perform searches or queries against the data as requested by other modules or other components.

Rules manager 315 may update a rules configuration file. The rules manager may maintain an up-to-date rules configuration file for a particular type of environment, provide the updated rules configuration file with agent modules being installed in a particular environment, and update rule configuration files for a particular agent based on data and metrics that the agent is providing to application 152. In some instances, rules manager 315 may periodically query timeseries database 310 for new data or knowledge received by agent 116 as part of monitoring a particular client application. When rules manager 315 detects new data, the rule configuration file is updated to reflect the new data.

Model builder 320 may build and maintain a model of the system being monitored by an agent. The model built by model builder 320 may indicate system nodes, pods, relationships between nodes, node and pod properties, system properties, and other data. Model builder 320 may consistently update the model based on data received from timeseries database 310. For example, model builder 320 can scan, periodically or based on some other event, time-series metrics and their labels to discover new entities, relationships, and update existing ones along with their properties and statuses. This enables queries on the scanned data and for generating and viewing snapshots of the entities, relationships, and their status in the present and arbitrary time windows at different points in the time. In some embodiments, schema .yml files can be used to describe entities and relationships for the model builder.

An example of model schema example snippets, for purpose of illustration, are below:

Source: Graph

type: HOSTS
startEntityType: Node
endEntityType: Pod

definedBy:
source: ENTITY_MATCH
matchOp: EQUALS
startPropertyLabel: name
endPropertyLabel: node
staticProperties:
   cardinality: OneToMany

### Source: Metrics

type: CALLS

startEntityType: Service

endEntityType: KubeService

definedBy:

source: METRICS

pattern: group by (job, exported_service) (nginx_ingress_controller_requests)

startEntityNameLabels: [“job”]

endEntityNameLabels: [“exported_service”]

Cloud knowledge graph 325 may be built based on the model generated by model builder 320. In particular, the cloud knowledge graph can specify relationships and properties for nodes in a system being monitored by agents 116-136. The cloud knowledge graph is constructed automatically based on data written to the time series database and the model built by model builder 320.

A cloud knowledge index may be generated as a searchable index of the cloud knowledge graph. The cloud knowledge index includes relationships and nodes associated with search terms. When a search is requested by a user of the system, the cloud knowledge index is used to determine the entities for which data should be provided in response to the search.

Knowledge sensor 335 may detect new data in timeseries database 310. The new knowledge, such as new metrics, event data, or other timeseries data, may be provided to rules manager 315, model builder 320, and other modules. In some instances, knowledge sensor 335 may be implemented within timeseries database 310. In some instances, knowledge sensor 335 may be implemented as its own module or as part of another module.

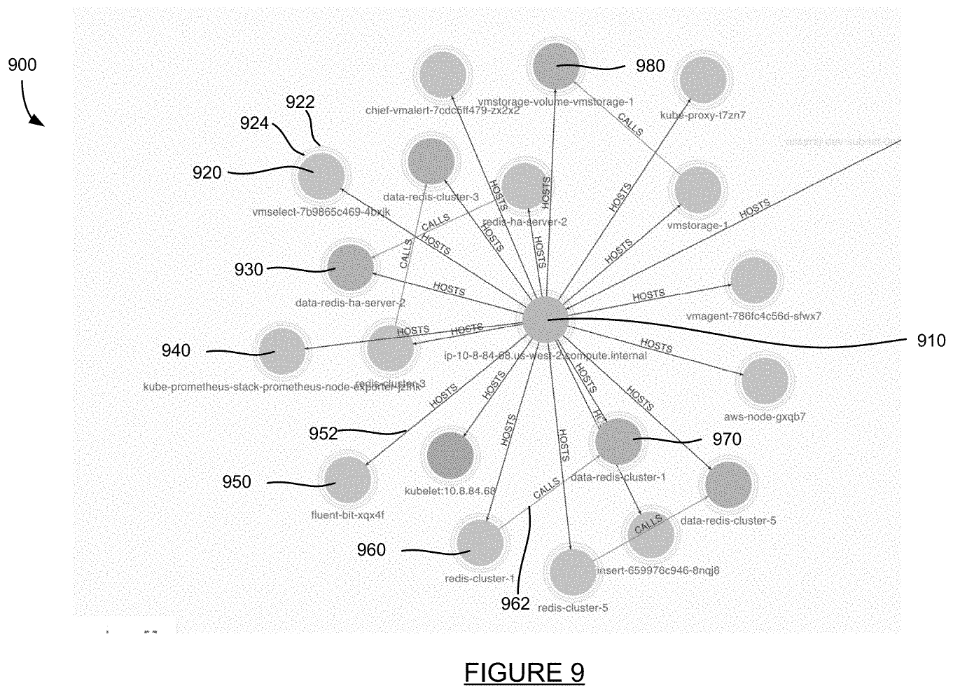

GUI manager 340 may manage a graphical user interface provided to a user. The GUI may reflect the cloud knowledge graph, and may include system nodes, node relationships, node properties, and other data, as well as one or more dashboards for data requested by a user. Examples of interfaces provided by GUI manager 340 are discussed with respect to FIGS. 9-11.

Rule configuration file 345 may include one or more files contain one or more rules which specify a metrics, events, aggregation parameters, storage parameters, and transmission parameters for an agent to operate based on. Rule configuration file 345 may be updated by rules manager 315 and transmitted by rules manager 315 to one or more agents that are monitoring remote applications.

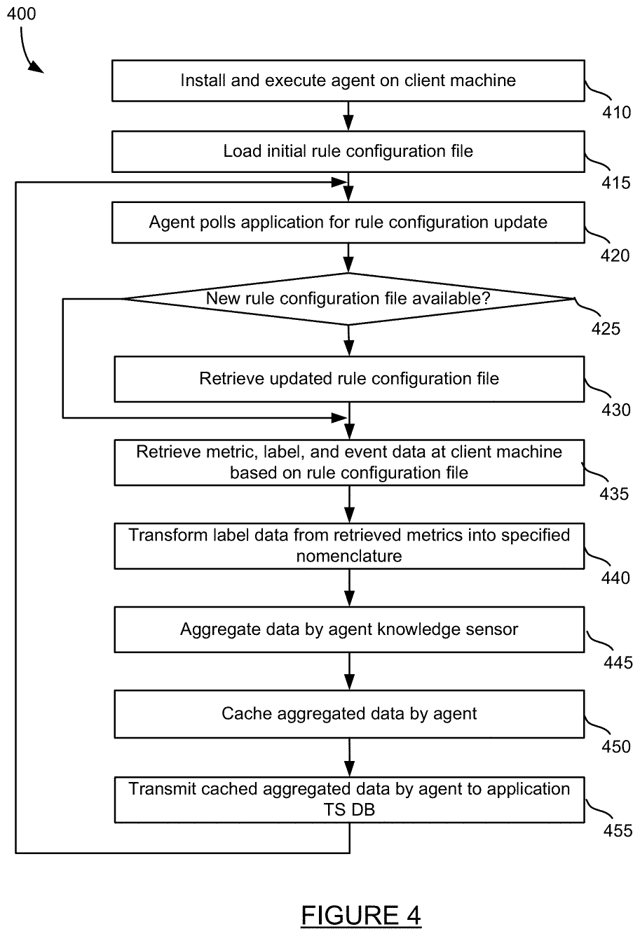

FIG. 4 is a method for monitoring a cloud service. The method of FIG. 4 can be implemented by one or more agents installed on one more applications and/or cloud environments that comprise a client's computing system.

First, an agent is installed and executed on a client machine at step 410. In some instances, an agent may be installed outside the code of an application, such as application 118. For example, agent 116 may be implemented in its own standalone container within environment 110. An initial rule configuration file is loaded by the agent at step 415. Agent 116, when installed, may include an initial rule configuration file. The rule configuration file may be constructed for the particular environment 110, resources being used by application 118, and based on other parameters.

An agent may poll application 152 for an updated rule configuration file at step 420. In some instances, a knowledge sensor within agent 116 may poll application 152 for an updated rule configuration file. A new rule configuration file may exist based on rules learned by the system. In some instances, a client may provide rules which are provided to application 152. If a new rule configuration file is determined to be available at step 425, the updated rule configuration file is retrieved at step 430 by the agent, and FIG. 4 continues to step 435. If no rule configuration file is available, operation of FIG. 4 continues to step 435.

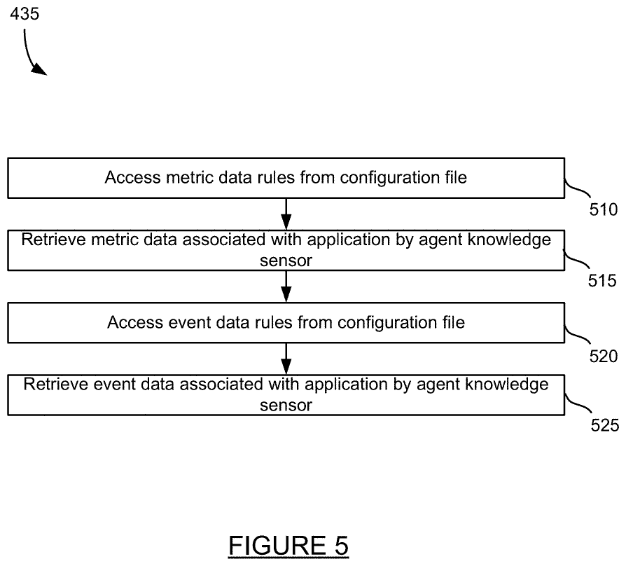

Metric label and event data are retrieved at a client machine based on the rule configuration file at step 435. Retrieving metric, label, and event data may include an agent accessing rules and retrieving the data from a client application or environment by the agent. Retrieving metric, label, and event data is discussed in more detail with respect to the method of FIG. 5.

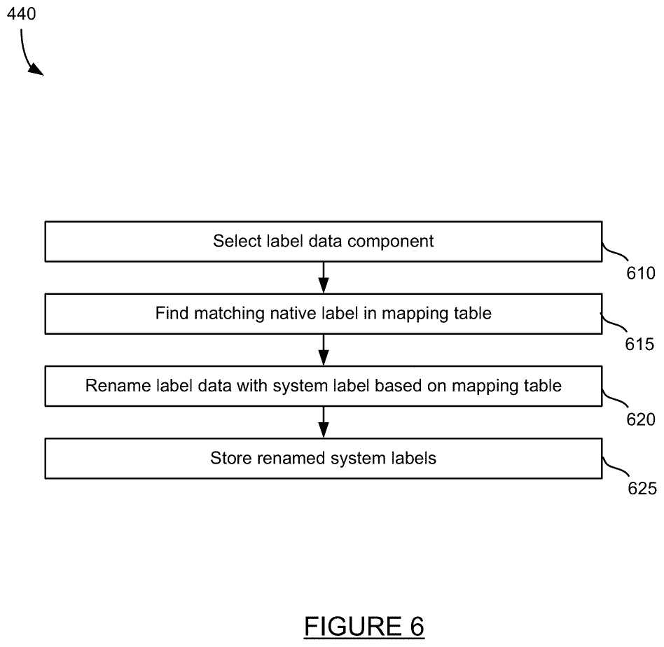

Label data is transformed from the retrieved metrics into a specified nomenclature at step 440. In some instances, metric data from different systems may have labels with different strings or characters, or exist in different formats. The present system automatically transforms or rewrites the existing metric label data into a specified nomenclature which allows the metrics to be aggregated and reported more easily. More detail for transforming label data from retrieved metrics is discussed with respect to the method of FIG. 6.

Data is aggregated by an agent at step 445. The data may be aggregated by a knowledge sensor at the agent. The aggregation may be performed as specified in the rule configuration file provided to agent 116 by application 152.

Aggregated data may be cached by the agent at step 450. The data may be cached and stored locally by the agent until it is transmitted to application 152 to be stored in a timeseries database. The caching and time at which the data is transmitted is set forth with the data configuration file.

The cached aggregated data is transmitted by an agent to the application at step 455. The data may be transmitted by an agent from a client application or elsewhere within an environment to a timeseries database of application 152. The time at which the cached aggregated data is transmitted is set by the data configuration file. In some instances, the cached aggregated data may also be transmitted in response to a request from application 152 or detection of another event from an agent in an environment 110, 120, or 130.

FIG. 5 is a method for retrieving metric, label, and event data at a client machine based on a rule configuration file. The method of FIG. 5 provides more detail for step 435 of the method of FIG. 4. First, rules for capturing metrics are accessed from a rule configuration file at step 510. Metric data associated with an application is then retrieved by a knowledge sensor on the agent within the client environment at step 515. Retrieving metric data may include polling application end points, polling a cloud watch service, polling a system monitoring and alert service, or otherwise polling code that implements or monitors a client application within one or more client environments.

Event data rules may then be accessed from the rule configuration file at step 520. The event data associated with an application is then retrieved by a knowledge sensor on the agent at step 525. In some instances, retrieving data may include calling and points of an application, cloud watch service, or system monitoring and alert service, as well as detecting events that occur within the environment. The events that are captured by an agent may include new deployments, scale up events, scale down events, configuration changes, and so forth.

In some instances, retrieving data for a client system can also include capturing cloud provider data. A knowledge sensor within the agent can poll and/or otherwise capture cloud provider data for different instance type data. For example, knowledge base and application 152 may retrieve data such as the number of cores used by an application, the memory usage, the cost per hour of using the cores and memory, metadata, and other static components. In some instances, a knowledge sensor outside the agent, for example within an application 152, can poll a cloud provider to obtain cloud provider data.

FIG. 6 is a method for transforming label data into a specified nomenclature. The method of FIG. 6 provides more detail for step 440 the method of FIG. 4. A label data component is selected at step 610. The selected label is found in a mapping table at step 615. The renamed system labels are then stored at step 625. In some instances, a configuration file includes mapping from a native format to present system format for different cloud providers. The mapping file associated with the cloud provider in which the client application is implemented is used to perform the label rewriting for the retrieved metric.

The mapping table includes the selected label and maps that label to a corresponding system label. The selected label is then renamed with the system label based on the mapping table at step 620.

For example, when a metric is obtained, for example by polling a cloud watch service, the metric will have several labels. The agent knowledge sensor can rewrite the labels to conform with a nomenclature used uniformly for different environments by the present system. The uniform properties can then be used as properties displayed in a graphical portion of an interface. For example, for a Kubernetes environment, an operating system label may be renamed to “os_image” while for a non-Kubernetes environment, an operating system label may be renamed to “sysname.”

Additionally, different client application requests can be relabeled in different ways. For example, inbound request and outbound requests can be relabeled into “request types,” with metadata that specified type of request (i.e., inbound, outbound, time request, and so forth). Another relabeling involves a “request context,” which provides additional details for the type itself. For example, an inbound request may include a uniform resource label with a login as the “request context.” The system may map both metrics and labels within the metric to a unique nomenclature that is implemented for several different computing environments having different metric formats and labels, which provides a more consistent analysis and reporting of client applications and systems.

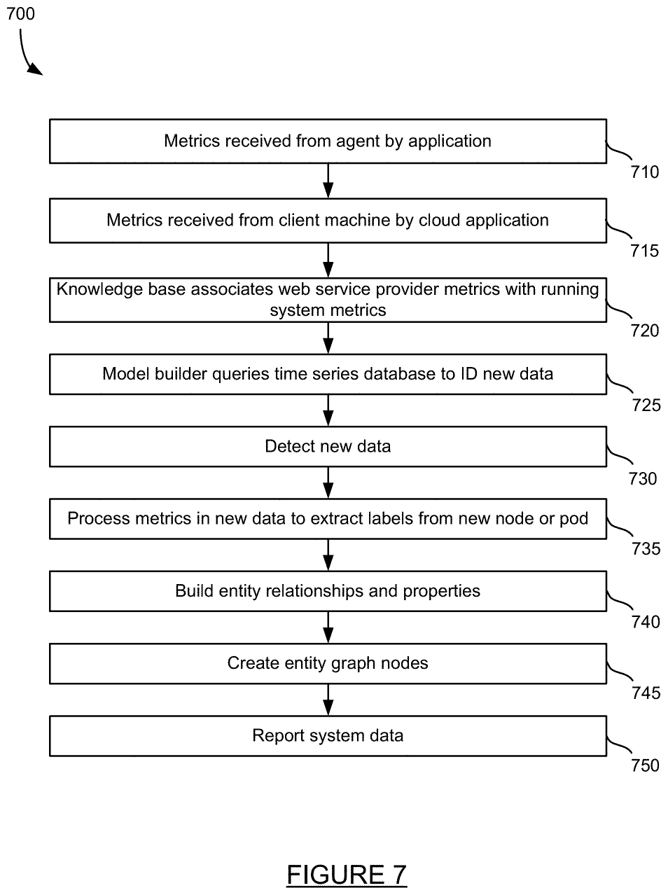

FIG. 7 is a method for processing data by an application. The method of FIG. 7 may be performed by application 152 of server 150. First, metrics are received from an agent by application 152 at step 710. Metrics can be received from a client machine by cloud application at step 715. The metrics received from a client machine may include specific metrics provided to application 152 by an administrator of client application 118.

Web service provider metrics are then associated with running system metrics at step 720. In some instances, a knowledge base module on application 152 may associate the web service provider metrics with the running system metrics. A model builder may then query the timeseries database to identify new data at step 725. New data may be detected at step 730, and the new data metrics are processed to extract labels at step 735. The new labels may be extracted for a new node or pod, or some other aspect of an environment 110 and client application 118 executing within environment 110. In some instances, labels extracted from metrics may include a service name, the name space on which it runs, a note, connecting pods and containers, and other data. In some instances, the data is stored in a YAML file.

Entity relationship properties are built at step 740. To build entity relationship properties, the YAML file is analyzed and updated with relationships detected in the metric stored in the timeseries database. In some instances, relationships between entities are established by matching metric labels or entity properties. For example, an entity relationship may be associated with call graphs (calls between services), deployment hierarchy (nodes, disk volumes, pods), and so forth.

Entity graph nodes are created at step 745. The nodes created in the entity graph include metric properties and relationships with other nodes. System data is then reported at step 750. Entities in the graph can be identified by a unique name. In some instances, one or more metric labels can be mapped as an entity name. The data may be reported through a graphical user interface, through queries handled by a knowledge base index, a dashboard, or in some other form.

In some instances, the entity graph nodes may be generated from a model created from metrics. The metrics can be mapped to the model, which allows for dynamic generation of a dashboard based on request, latency, error, and resource metrics. The model may be based on metrics related to saturation of resources (CPU, memory disk, network, connection, GC), anomaly (e.g., request rate), amending a new deployment, configuration or secrets change, and scale up or scale down. The method may also be based on failure and fault (domain specific), and error ratio and error budget burn SLOs.

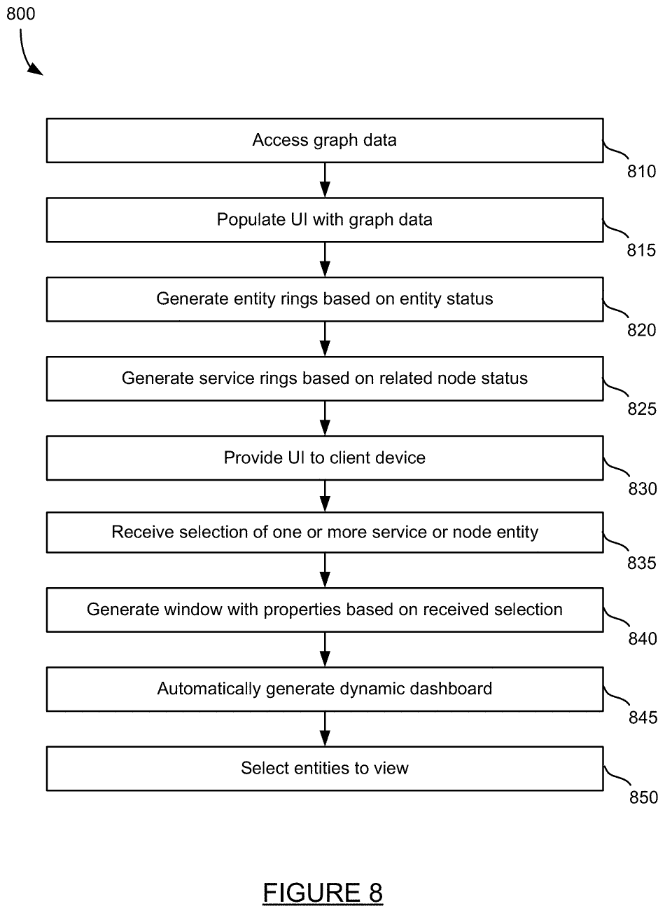

FIG. 8 is a method for reporting process data through an interface. First, graph data is accessed at step 810. The graph data may include the model data and YAML file data. The UI may be populated with graph data at step 815. Populating the UI with graph data may include populating individual nodes and node relationships. Entity rings may be generated based on the entity status at step 820. Service rings may be generated based on a related node status at step 825. A user interface is then provided to a client device at step 830.

A selection may be received for one or more system entities (e.g., nodes) at step 835. In some instances, a window may be generated within an interface with properties based on the received selection at step 840. A dynamic dashboard may be automatically generated at step 845. Entities for viewing are selected and provided through the interface at step 850. Examples of interfaces for reporting system entity data is discussed with respect to FIGS. 9-14.

FIG. 9 illustrates a node graph for a monitored system. The node graph 900 of FIG. 9 includes nodes 910, 920, 930, 940, 950, 960, 970, and 980. Some of the nodes may represent servers or machines, such as node 920, which represents a virtual machine. Similarly, node 940 represents a Prometheus node, and node 960 represents a redis node. Some nodes may represent a data store or other storage system, such as node 930 that represents a data server, node 970 that represents a data cluster, and 980 which represents a virtual machine storage server.

Each node in the node graph 900 may be surrounded with a number of rings. For example, node 120 includes outer ring 922 and inner ring 924. The rings around a node indicate the status of components within the particular node. For example, if a node is associated with two servers, the node will have two rings, wherein each ring representing one of the two servers.

Each node in the node graph may be connected via one or more lines to another node. For example, parent node 910 represents a parent or root node or server within the monitored system. A line may exist from parent node 910 to one or more other nodes, and may indicate the relationship between the two nodes. For example, line 952 between node 910 and 950 indicates that node 910 hosts node 950. Lines may also depict relationships between nodes other than the parent node or root node 910. For example, line 962 between node 960 and 970 indicates that node 960 may call node 970.

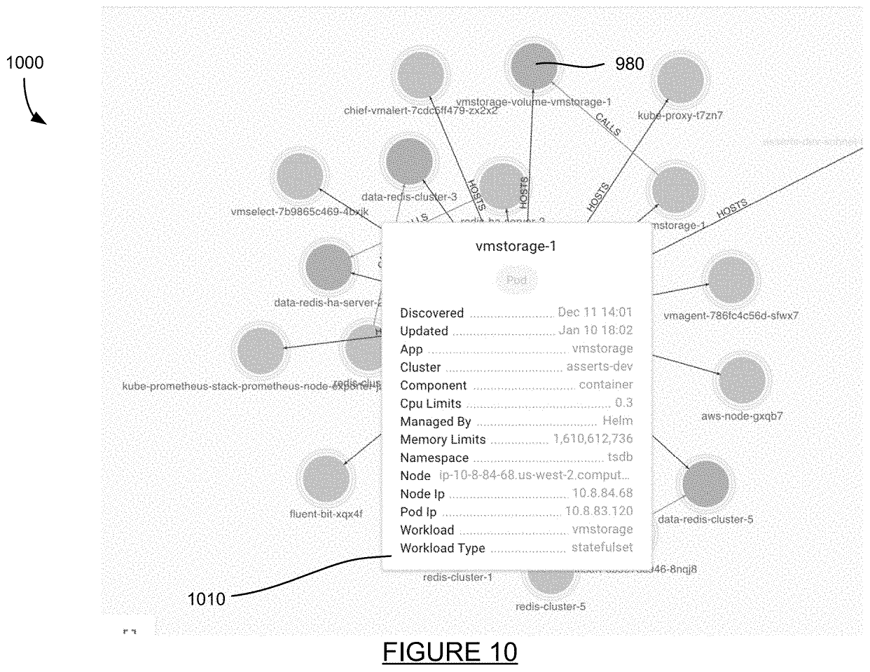

FIG. 10 illustrates properties provided for a selected node in a node graph for a monitored system. The illustration of FIG. 10 includes properties window 1010, which is displayed upon selection of node 980, titled “vmstorage-1.” In properties window 1010, the window indicates that the properties are for a node considered a pod, and provides information regarding node history, content, and location. In particular, the properties for the selected node may include a discovered date, updated date, application name, cluster name, components name, CPU limits, what the node is managed by, memory limits, namespace, node IP address, the node IP, pod IP, workload, and workload type. Different properties may be illustrated for different types of nodes, the properties provided may be default properties or configured by an administrator.

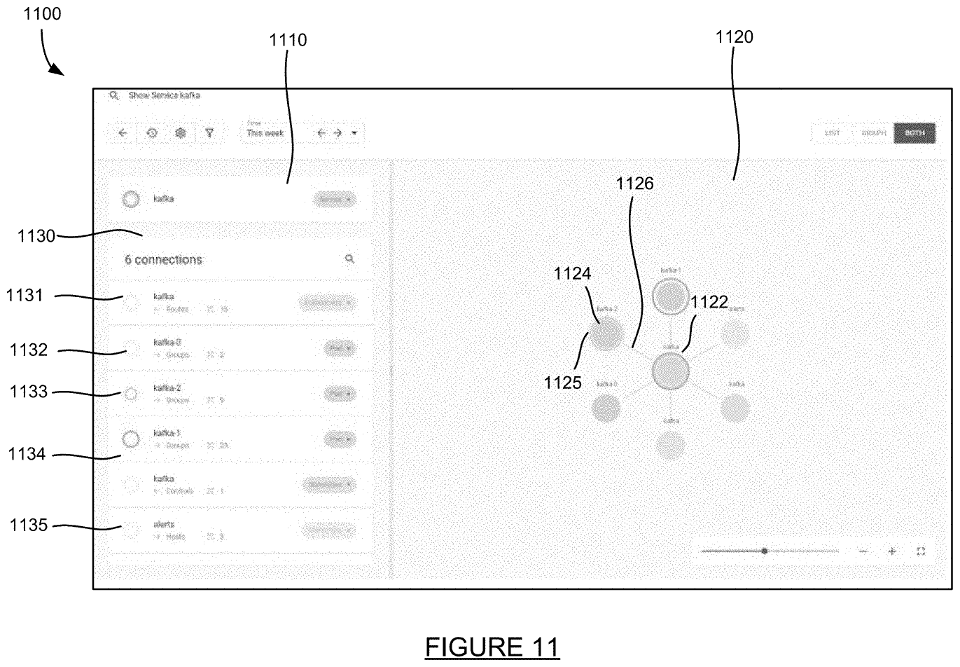

FIG. 11 illustrates a user interface for reporting a cloud service data for a monitored system. The interface 1100 of 11 FIG. 11 includes a graphical representation of nodes 1120, a listing of node connections 1120, and other elements. In the graphical representation of nodes, a parent node 1122 is illustrated having relationships with six other child nodes, including node 1124. The relationship between the parent node 1122 and each parent node is represented by a relationship connector, such as the relationship connector 1126.

A status indicator can be generated for each node. The status indicator can indicate the status of each node. The status indicator of the parent node can indicate the overall status of the system within which the parent node operates. The status indicator can be graphically represented in a number of ways, including as a ring around a particular node. Ring 1125 around node 1124 indicates a status of node 1124.

The listing of node connections 1110 lists each child node 1130-945 that is shown in the graphical representation. For each child node, information provided includes the name of the child node, the number of total connections for the child node, the entity type for the node, and other data.

FIGS. 12 A-B illustrates properties reported for cloud service entity. When a selection is received for a node or a group of nodes within graphical representation 920, properties for the particular node or group of nodes is provided, for example in a pop-up window within the interface. FIGS. 1212A and 1212B each illustrate a portion of a pop-up window. The interface 1200 of FIG. 1212A indicates, for a “kafka cluster” node, information from a menu of options 1201. The information includes properties 1202, which includes namespace, workload, workload type, and pod count. Additional properties include CPU 1204, memory 1206, disk 1208, and KPI data 1210. The interface of FIG. 1212B provides CPU, memory, and disk data in a graphical format 1212, message rate data 1214, event data 126, and related entities data 1218.

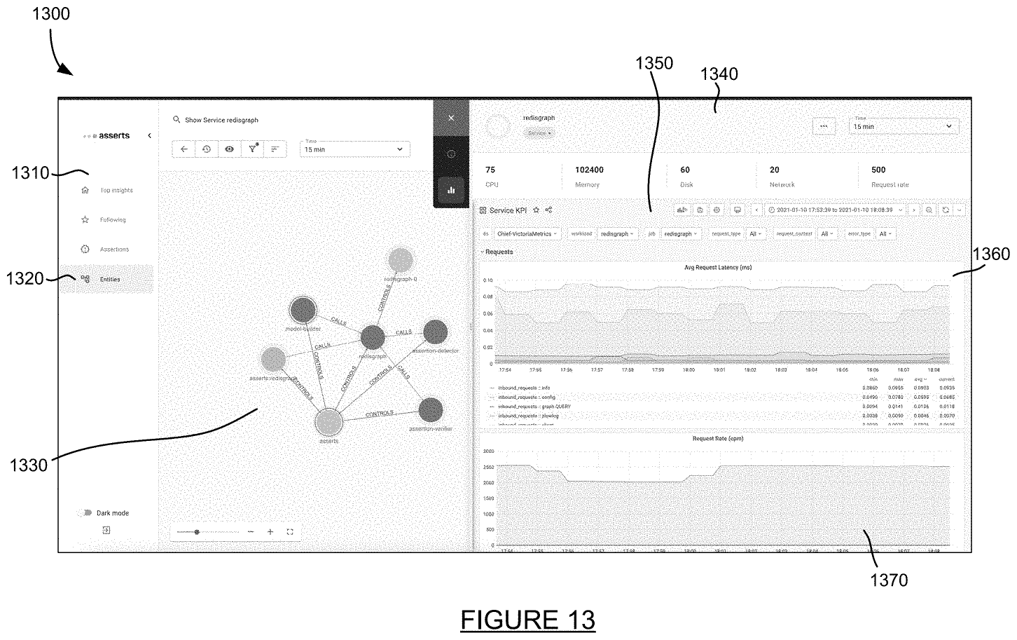

FIG. 13 illustrates a dashboard for reporting cloud service data. The dashboard of FIG. 13 includes a dashboard selection menu 1310, a node graph 1330, node information window 1340, and node data 1316 and 1370. Dashboard selection menu 1310 allows a user to view the top insights, information for favorite nodes, assertions, or entities. Currently, entities 1320 is selected within the dashboard selection menu. As such, entities are currently displayed in node graph 1330 within the dashboard.

Node information window 1340 provides information for the currently selected node. As indicated, the currently selected node is “redisgraph”, which is categorized as a service. It is shown that the node has two rings, and data is illustrated for the node over the last 15 minutes. The illustrated data for the selected node includes CPU cycles consumed, memory consumed, disk space consumed, network bandwidth, and request rate.

Additional data for the selected node is illustrated in window 1350. The additional data includes the average request latency for a particular transaction within the node. In this case, the particular transaction is “Service KPI.” Data associated with the transaction is illustrated in graph area 1360. The graph area includes parameters such as associated job, request type, request context, and error type. The graph includes multiple displayed plots, with each plot associated with different transactions associated with a particular node. The transactions may be identified automatically by the present system and displayed automatically in the dashboard. In some instances, the automatically identified and displayed transactions are those associated with an anomaly, or some other undesirable characteristics. In graphic window 1370, the request rate for the particular service is illustrated. The request rate is provided over a period of time and shows the requests per minutes associated with the service.

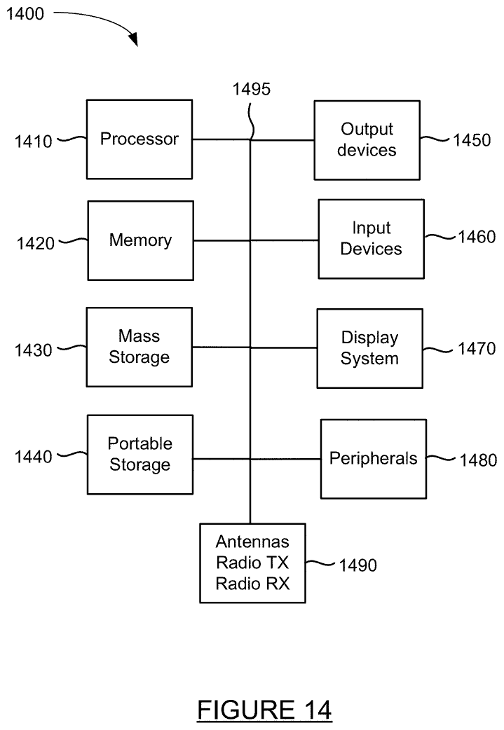

FIG. 14 is a block diagram of a system for implementing machines that implement the present technology. System 1400 of FIG. 14 may be implemented in the contexts of the likes of machines that implement applications 118, 128, and 138, client device 160, server 150, and client device 160. The computing system 1400 of FIG. 14 includes one or more processors 1410 and memory 1420. Main memory 1420 stores, in part, instructions and data for execution by processor 1410. Main memory 1420 can store the executable code when in operation. The system 1400 of FIG. 14 further includes a mass storage device 1430, portable storage medium drive(s) 1440, output devices 1450, user input devices 1460, a graphics display 1470, and peripheral devices 1480.

The components shown in FIG. 14 are depicted as being connected via a single bus 1490. However, the components may be connected through one or more data transport means. For example, processor unit 1410 and main memory 1420 may be connected via a local microprocessor bus, and the mass storage device 1430, peripheral device(s) 1480, portable storage device 1440, and display system 1470 may be connected via one or more input/output (I/O) buses.

Mass storage device 1430, which may be implemented with a magnetic disk drive, an optical disk drive, a flash drive, or other device, is a non-volatile storage device for storing data and instructions for use by processor unit 1410. Mass storage device 1430 can store the system software for implementing embodiments of the present invention for purposes of loading that software into main memory 1420.

Portable storage device 1440 operates in conjunction with a portable non-volatile storage medium, such as a floppy disk, compact disk or Digital video disc, USB drive, memory card or stick, or other portable or removable memory, to input and output data and code to and from the computer system 1400 of FIG. 14. The system software for implementing embodiments of the present invention may be stored on such a portable medium and input to the computer system 1400 via the portable storage device 1440.

Input devices 1460 provide a portion of a user interface. Input devices 1460 may include an alpha-numeric keypad, such as a keyboard, for inputting alpha-numeric and other information, a pointing device such as a mouse, a trackball, stylus, cursor direction keys, microphone, touch-screen, accelerometer, and other input devices. Additionally, the system 1400 as shown in FIG. 14 includes output devices 1450. Examples of suitable output devices include speakers, printers, network interfaces, and monitors.

Display system 1470 may include a liquid crystal display (LCD) or other suitable display device. Display system 1470 receives textual and graphical information and processes the information for output to the display device. Display system 1470 may also receive input as a touch-screen.

Peripherals 1480 may include any type of computer support device to add additional functionality to the computer system. For example, peripheral device(s) 1480 may include a modem or a router, printer, and other device.

The system of 1400 may also include, in some implementations, antennas, radio transmitters and radio receivers 1490. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth device, and other radio frequency networks. The devices may include one or more radio transmitters and receivers for processing signals sent and received using the antennas.

The components contained in the computer system 1400 of FIG. 14 are those typically found in computer systems that may be suitable for use with embodiments of the present invention and are intended to represent a broad category of such computer components that are well known in the art. Thus, the computer system 1400 of FIG. 14 can be a personal computer, handheld computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, as well as languages including Java, .NET, C, C++, Node.JS, and other suitable languages.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for automatically generating an application knowledge graph, comprising:
receiving a first set of metrics with labels from one or more agents monitoring a client system in one or more computing environments, the first set of received metrics and labels having a universal nomenclature that is different than a native computing environment nomenclature for the metrics and labels;
analyzing the first set of received metrics and labels to identify the metrics and labels;
automatically generating a knowledge graph based on the set of metrics and labels;
receiving a new set of metrics and labels from the one or more agents;
automatically updating the knowledge graph based on the new set of metrics and labels; and
reporting the updated knowledge graph data to a user.

2. The method of claim 1, wherein the knowledge graph includes nodes and node relationships associated with the client system.

3. The method of claim 1, further comprising automatically generating a rule configuration file based on the received first set of metrics with labels, the rule configuration file transmitted to the agent to indicate what metrics and labels the agent should subsequently retrieve from the client system, the new set of metrics retrieved by the agent based on the rule configuration file.

4. The method of claim 3, further comprising generating an updated rule configuration file based on the new metrics and labels;

5. The method of claim 1, further comprising:
detecting labels associated with the metrics received from the one or more agents; and
constructing entity relationships between a plurality of nodes within the client system based on the labels.

6. The method of claim 1, further comprising determining properties for one or more of the plurality of nodes from the labels associated with the metrics

7. The method of claim 1, wherein the metrics and labels are in a time series format

8. The method of claim 1, further comprising storing the received metrics and labels in a data store.

9. The method of claim 1, wherein the updated knowledge graph is reported to the user through a graphical interface.

10. A method for automatically monitoring a client application in a cloud environment; comprising:
retrieving metrics having labels from a client application by an agent executing in a computing environment with the client application, the agent retrieving metrics based on a first rule configuration file;
transmitting metrics to a processing application executing on a remote server;
receiving an updated rule configuration file from the processing application, the updated rule configuration file specifying changes to the metrics to be retrieved by the agent, the updated rule configuration file automatically generated by the processing application based on the metrics transmitted by the agent to the processing application; and
retrieving metrics having labels from the client application by the agent based on the updated rule configuration file.

11. The method of claim 10, wherein the first rule configuration file is specific to the agent and the first computing environment.

12. The method of claim 10, further including rewriting the metrics and the labels to a uniform nomenclature by the agent.

13. The method of claim 10, further comprising aggregating and caching the rewritten metrics and labels based on aggregation and caching data in the first rule configuration file, wherein the agent transmits the aggregated and cached metrics based on transmission data specified in the first rule configuration file.

14. The method of claim 10, further comprising:
polling the processing application for a new rule configuration file by the agent; and
receiving an updated rule configuration file by the agent from the processing application in response to the poll.

15. The method of claim 10, further comprising:
retrieving metrics having labels from a second client application in a second computing environment; and
rewriting the metrics and the labels to a uniform nomenclature by the agent using a mapping file generated to map metrics and labels specific to the second computing environment, wherein rewriting the metrics and the labels to a uniform nomenclature by the agent in the first computing environment is performed using a mapping file generated to map metrics and labels specific to the first computing environment.

16. A non-transitory computer readable storage medium having embodied thereon a program, the program being executable by a processor to perform a method for automatically generating an application knowledge graph, the method comprising:
receiving a first set of metrics with labels from one or more agents monitoring a client system in one or more computing environments, the first set of received metrics and labels having a universal nomenclature that is different than a native computing environment nomenclature for the metrics and labels;
analyzing the first set of received metrics and labels to identify the metrics and labels;
automatically generating a knowledge graph based on the set of metrics and labels;
receiving a new set of metrics and labels from the one or more agents;
automatically updating the knowledge graph based on the new set of metrics and labels; and
reporting the updated knowledge graph data to a user.

17. A system for automatically generating an application knowledge graph, comprising:
a server including a memory and a processor; and
one or more modules stored in the memory and executed by the processor to receive a first set of metrics with labels from one or more agents monitoring a client system in one or more computing environments, the first set of received metrics and labels having a universal nomenclature that is different than a native computing environment nomenclature for the metrics and labels, analyze the first set of received metrics and labels to identify the metrics and labels, automatically generate a knowledge graph based on the set of metrics and labels, receive a new set of metrics and labels from the one or more agents, automatically update the knowledge graph based on the new set of metrics and labels, and report the updated knowledge graph data to a user.
